(19) United States
(12) Patent Application Publication
(10) Pub. No.: US 2009/0214462 A1
(43) Pub. Date: Aug. 27, 2009

(54) COCKCROACH JELLY BAIT

(75) Inventor: Hao-Jan Lin, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: SONDLIN TECHNOLOGY CORP., Taipei City (TW)

(21) Appl. No.: 12/202,317

(22) Filed: Aug. 31, 2008

Related U.S. Application Data
(63) Continuation-in-part of application No. 10/754,385, filed on Jan. 12, 2004, now abandoned.

(51) Int. Cl. A01N 25/04; A01P 19/00

(52) U.S. Cl. 424/84

(57) ABSTRACT

The present invention provides jelly bait for carrying insecticide to kill cockroaches. The jelly bait benefits from maintaining its softness for longer periods of time, which results in higher successful rates in luring and then killing cockroaches. The jelly bait can be injected with a syringe into the crevices or cockroach habitats for best effects in eradication of cockroaches.

### CROSS-REFERENCE TO RELATED APPLICATION

This application is a continuation-in-part of a prior application Ser. No. 10/754,385, filed Jan. 12, 2004. The entirety of the above-mentioned patent application is hereby incorporated by reference herein and made a part of this specification.

### BACKGROUND OF THE INVENTION

1. Field of Invention

The present invention relates to insect baits, particularly a jelly bait suitable for cockroaches.

2. Description of Related Art

Cockroach traps or baits found in the market may kill the male cockroaches roaming about for food, but not the female cockroaches and nymphs which tend to hide and feed in the crevices without coming out. Even using spraying type insecticides, the effective dosage of insecticides which would reach to the bottom of the crevices is limited, and the result is unsatisfactory. As these traditional methods kill mostly the male, rather than the female cockroaches and nymphs, the eradication of the whole cockroach population is ineffective. To be effective, the cockroach traps or baits must be made available to the female cockroaches and the nymphs hiding in the crevice.

One technique was disclosed by U.S. Pat. No. 6,007,832, which uses a sticky jelly for carrying the poison to kill the cockroaches. However, because the disclosed jelly solidifies in short time, the cockroaches have no interests in the solidified jelly and the jelly is ineffective in killing the cockroaches.

### SUMMARY OF THE INVENTION

This invention provides a jelly bait suitable for killing the cockroaches or eradicating the cockroach colony.

An object of the invention is to provide an insecticidal bait for killing the cockroaches hiding in crevices.

Another object is to provide an insecticidal bait, in an injectable form, for applying to the places where cockroaches go into hiding.

Still another object of this invention is to provide an insecticidal jelly bait, which is capable of maintaining the softness or moistness of the jelly for longer periods of time to lure the cockroaches, thus leading to higher killing rates.

As embodied and broadly described herein, the jelly bait includes boric acid as an insecticide for poisoning cockroaches. The jelly bait also includes pectin and a moisture-retention agent that can preserve or maintain the moisture of the jelly bait. As the moist jelly bait is highly attractive for various kinds of cockroaches, killing rate of cockroaches becomes higher and faster due to the large or high intake of the poison or insecticide within the jelly bait.

It is to be understood that both the foregoing general description and the following detailed description are exemplary, and are intended to provide further explanation of the invention as claimed.

### DESCRIPTION OF THE PREFERRED EMBODIMENTS

Although the bait provided by the present invention directs to bait in a “jelly” form, and mentioned as jelly bait herein and in the following contexts. The baits in the jelly or gelatinous form principally include pectin from the plant sources, i.e. from vegetables or fruits. The jelly bait of the present invention also includes an insecticide for poisoning the cockroaches, a moisture-retention agent for preserving the moisture of the jelly bait, and/or a food bait for alluring purposes. The following examples describe the composition of the jelly baits according to the present invention.

### Example I

Using boric acid as principal insecticide: the ingredients as follows:

TABLE 1

| | Exemplary weight | Weight % |
|---|---|---|
| | % concentration | concentration allowed |
| | (w/w) (relative to | (w/w) (relative to |
| | the total weight | the total weight |
| | of the jelly bait) | of the jelly bait) |
| Low Methoxyl | 0.8% | 0.6% to about 10% |
| Pectin | | |
| (LMP) | | |
| Food bait | 1.0% | 0.5% to about 2% |
| CaCl₂ | 1000 ppm | 50-3000 ppm |
| Boric acid | 30% | 20%-60% |
| Water | 68.2% | Appropriate amount to jellify |

Tested Cockroach: Stipella longipalpa

Test of Effectiveness:

A. Equipment: Bait box, sized 25×15×17 cm³, covered to prevent cockroaches from climbing out.

B. Method: Step I. Load 1.5 gram tested jelly bait in a plastic petri dish and place inside the bait box. Also provide food and water in the bait box near where cockroaches may hide. Step II. Release cockroaches in the test box and let the cockroaches to eat freely for eight consecutive days. The mortality rate is recorded daily.

C. Results: as shown in the following Table 2.

TABLE 2

| | Days after feeding | | | | | | | |
|---|---|---|---|---|---|---|---|---|
| | 1 | 2 | 3 | 4 | 5 | 6 | 7 | 8 |
| Death rate | 3.3 ± 5.8 | 13.3 ± 15.3 | 30.0 ± 10.0 | 33.3 ± 5.8 | 53.3 ± 5.8 | 70.0 ± 10.0 | 96.7 ± 5.8 | 100 ± 0.0 |
| (%) | | | | | | | | |

### Example II

Using chlorpyrifos as the principal insecticide: the ingredients as follows:

TABLE 3

| | Exemplary | Weight % |
|---|---|---|
| | weight % | concentration allowed |
| | concentration (w/w) | (w/w) (relative to |
| | (relative to the total | the total weight |
| | weight of the jelly bait) | of the jelly bait) |
| Low Methoxyl | 0.8% | 0.6% to about 10% |
| Pectin (LMP) | | |
| Food bait | 1.0% | 0.5% to about 2% |
| CaCl₂ | 1000 ppm | 50-3000 ppm |
| Boric acid | 2% | 0.5%-3% |
| Water | 96.2% | Appropriate amount to jellify |

The test method is the same as Example I. The results are shown in the following Table 4.

TABLE 4

| | Days after feeding | | | | | | | |
|---|---|---|---|---|---|---|---|---|
| | 1 | 2 | 3 | 4 | 5 | 6 | 7 | 8 |
| Death rate | 43.3 ± | 63.3 ± | 96.7 ± | 100 ± 0.0 | xx | xx | xx | xx |
| (%) | 5.8 | 15.3 | 5.8 | | | | | |

The food bait used in our tests is water soluble and dissolved easily without affecting jellification after the introduction of CaCI₂ into the pectin solution. There are many kinds of food baits well known in prior art. The jelly bait of the present invention can contain food baits like onion, milk powders, flours, sugars, and/or meat etc. without affecting the jellifying ability. Based on our observation, different kinds of cockroaches such as Periplaneta Americana, Blattella germanica or Periplaneta brunnea do not differ significantly in their preferences of food baits. They all prefer jelly type baits with high water content. Therefore, the tested results should be applicable to any other kinds of cockroaches.

Boric acid has been known for its low solubility in water and the delayed action as an insecticide. The killing mechanism can be divided into two categories. The first category is to kill by contact and requires over 40% suspended content in the jelly to be effective. The second category is to kill by intake and requires 10-40% suspend content in the jelly. The cockroaches would die one to eight days after intake.

Chlorpyrifos is an organic phosphate. Due to low insect repellent property, it is widely used as a low toxicity insecticide. It is available in the market with 40.8% concentration soluble in water and can be mixed with pectin solution to form milky gel. Such an insecticide has faster action, commonly with 1-2% dosage. Cockroaches usually die in 2-3 days after intake.

### Example III

### Low Methoxyl Pectin-Amidated, LMPA

To prepare pectin-mediated jelly bait, the LMP can also be replaced with Low methoxyl pectin-amidated, LMPA, with other ingredients remain unchanged. The LMPA can be obtained through amidated process to the carboxy group in LMP to become LMPA. The LMPA can also jellify in the presence of II valence metal ion similar to LMP. The advantage over LMP is that the melting point of the jelly is higher up to 150.degree. C., whereas the LMPA jelly would melt at 75.degree. C. At pH value below 3.4, the hardness of the LMPA jelly is higher than that of LMP jelly.

### Example IV

Using boric acid as principal insecticide together with a moisture-retention agent (e.g. glycerol): the ingredients as follows:

TABLE 5

| | Exemplary weight | Weight % |
|---|---|---|
| | % concentration | concentration allowed |
| | (w/w) (relative to | (w/w) (relative to |
| | the total weight of | the total weight of |
| | the jelly bait) | the jelly bait) |
| Pectin | 2% | 0.6% to about 10% |
| Food bait | 2% | 0.5% to about 2% |
| glycerol | 20% | 10-30% |
| Boric acid | 30% | 20%-40% |
| Water | 46% | 20%-70% |

Tested Cockroaches: Blattella germanica & Periplaneta americana

Test of Effectiveness:

A. Equipment: Bait box, sized 25×15×17 cm³, covered with Fluon to prevent cockroaches from climbing out.

B. Method: Step I. Load 1.0 gram tested jelly bait as recited in Table IV in a plastic petri dish and place the dish inside the bait box. Also provide food and water in the bait box near where cockroaches may hide. Step II. Release 10 cockroaches (Periplaneta americana) or 20 cockroaches (Blattella germanica) in the test box and let the cockroaches to eat freely for seven consecutive days. The death rate of the cockroaches is recorded daily. The control group is tested under the same environment, but feed with syrup.

C. Results: as shown in the following Table 6.

TABLE 6

| Tested | | Death rate (%) on each recorded day | | | | | | | |
|---|---|---|---|---|---|---|---|---|---|
| cockroach | Group | 1 | 2 | 3 | 4 | 5 | 6 | 7 | Total |
| Periplaneta | 1 | 100 | — | — | — | — | — | — | 100 |
| americana | | | | | | | | | |
| Periplaneta | 2 | 90 | 10 | — | — | — | — | — | 100 |
| americana | | | | | | | | | |
| Periplaneta | 3 | 100 | — | — | — | — | — | — | 100 |
| americana | | | | | | | | | |
| Periplaneta | Control | 0 | 0 | — | — | — | — | — | 0 |
| americana | | | | | | | | | |
| Blattella | 1 | 95 | 5 | — | — | — | — | — | 100 |
| germanica | | | | | | | | | |
| Blattella | 2 | 40 | 45 | 0 | 0 | 15 | — | — | 100 |
| germanica | | | | | | | | | |
| Blattella | 3 | 80 | 10 | 10 | — | — | — | — | 100 |
| germanica | | | | | | | | | |
| Blattella | Control | 0 | 0 | 0 | 0 | 0 | — | — | 0 |
| germanica | | | | | | | | | |

From the results of Table 6, it is shown that the death rate of the test groups for different kinds of cockroaches in general reaches 100% after taking the jelly bait of this invention for several days, while no cockroach in the control groups turns dead. Therefore, the jelly bait of this invention works effectively in killing cockroaches.

It is environmental-friendly to use boric acid as the major insecticide, without using the organic phosphates. Especially, for toxicity-sensitive environments, such as schools, kindergartens, food supplies factories, hospitals or kitchens, such jelly baits (using only boric acid together with glycerol) can eradicate cockroaches effectively without poisoning the environments or endangering the vulnerable ones.

While the preferred embodiments of the art have been described, it will be apparent to those skilled in the art that various modifications can be made in the embodiments without departing from the spirit of the present invention. Such modifications are all within the scope of this invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A jelly bait for attracting and killing cockroaches, comprising:
water with a weight percentage of 20% to 70% relative to a total weight of the jelly bait;
an insecticide consisting of boric acid with a weight percentage of 20% to 40% relative to the total weight of the jelly bait;
a pectin with a weight percentage of 0.6% to 10% relative to the total weight of the jelly bait;
a moisture-retention agent consisting of glycerol with a weight percentage of 10% to 30% relative to the total weight of the jelly bait; and
a food bait with a weight percentage of 0.5% to 2% relative to the total weight of the jelly bait, wherein the food bait comprises one or more selected from the group consisting of onion, milk powders, flours, sugars and meat.

2. The jelly bait of claim 1, wherein boric acid is present in a weight percentage of about 30%, and glycerol is present in a weight percentage of about 20% relative to the total weight of the jelly bait.

3. The jelly bait of claim 1, wherein pectin comprises low methoxyl pectin (LMP).

4. The jelly bait of claim 1, wherein pectin comprises low methoxyl pectin-amidated (LMPA).

5. The jelly bait of claim 1, wherein pectin consists of plant pectin.
